(19) United States
(12) Patent Application Publication
(10) Pub. No.: US 2023/0392442 A1
(43) Pub. Date: Dec. 7, 2023

(54) FOLDABLE LADDER

(71) Applicant: ZHEJIANG KING CHANCE CO., LTD., Yongkang City (CN)

(72) Inventor: Xiaofei PAN, Yongkang City (CN)

(21) Appl. No.: 18/034,354

(22) PCT Filed: Jun. 24, 2022
(86) PCT No.: PCT/CN2022/101341

§ 371 Date: Apr. 27, 2023

(30) Foreign Application Priority Data
Jun. 24, 2021 (CN) 202110706662.0

(51) Int. Cl. E06C 1/383; E06C 1/18; E06C 7/50; E06C 1/393

(52) U.S. Cl. CPC E06C 1/3835; E06C 1/18; E06C 7/50; E06C 1/393

(57) ABSTRACT

A folding ladder comprising two ladder frames rotatably connected by two oppositely arranged frame hinge assemblies at the top, the ladder frames each including two parallel ladder legs, and several ladder frames; the frame hinge assembly is provided with a balancing member, one end of the balancing member is hinged with one frame hinge assembly, and the other end is connected with another frame hinge assembly in a locking manner; each step comprises hinged left and right step sections, the tops of the two ends of each step are is with snap-fit notches, so that the steps do not collide with the legs during the rotation process, the steps are in contact with the legs in both the unfolded and folded states, which makes the overall structure compact and has better shockproof effect, which is convenient for the transportation of the whole folding ladder.

### TECHNICAL FIELD

The invention relates to the technical field of ladders, in particular to a foldable ladder.

### BACKGROUND OF THE ART

Foldable ladders are civil engineering supplies that assist workers to rise and fall on the construction site, just like movable stairs. The foldable ladder is opened when it is used, and folded up when it is used up, which is convenient for transfer. Foldable ladders require solid workmanship. Foldable ladders are widely used in various civil engineering and decoration projects. The convenience and dual-use of foldable ladders are favored by more and more people.

Foldable ladders can be divided into single-sided ladders and double-sided ladders according to their shapes. The single-sided ladders need to lean on the wall during use, while the double-sided ladders can be used independently. The telescopic structure adjusts the distance between adjacent steps by telescopically adjusting the outriggers, so as to realize the overall folding and storage of the ladder. The distance between the adjacent outriggers realizes the overall ladder folding and storage, and the adjacent outriggers are usually of a cross structure.

US Patent No. US20040026173A1 discloses a multi-folding collapsible ladder comprising a frame of left and right legs, a plurality of steps are arranged between the left and right legs. Each step includes a left step section pivotally connected to the left leg, a right step section are pivotally coupled to the right leg, and a slider hinge is pivotally coupled to each of the left and right step sections to support the left and right step sections for relative movement to one another about a step pivot shaft between an aligned position wherein the left and right step sections are arranged to lie in end-to-end relation to one another upon movement of the left and right legs to an opened position in which the left leg is arranged to lie in non-parallel relation to the right leg and a folded position wherein the left and right step sections are arranged to lie in side-by-side relation to one another upon movement of the left and right legs to a closed position in which the left leg is arranged to lie in parallel relation to the right leg, and a step mover including a rod and a first post on the rod, wherein the rod is slidably coupled to at least one of the slider hinges for movement relative to the left and right legs between a lowered position associated with the opened position of left and right legs and a raised position associated with the closed position of the left and right legs and wherein the first post is arranged on the rod to lie under and mate with a first of the slider hinges included in a first of the steps upon movement of the left and right legs to the opened position and to lie under and in spaced-apart relation to the first of the slider hinges upon movement of the left and right legs to the closed position.

The left leg and the right leg are set obliquely, and the extension line of the left leg and the right leg are crossed, so that the overall center of gravity is lower, and it has better stability during use.

However, in the actual production process, due to the inclined arrangement of the two ladder legs in the above-mentioned folding ladder, the sizes of the steps between the two ladder legs at different heights are different, and the sizes of the steps gradually decrease from bottom to top, therefore different molds should be designed to produce steps of different sizes, which increases the production cost, and during the installation process, it is necessary to correspond different steps to different connection positions of the ladder legs, which is time-consuming and labor-intensive.

At the same time, in the foldable ladder disclosed above, due to the different sizes of steps at different heights, when the steps are arranged at equal distances, the folding space of each step needs to be reserved according to the steps of the largest size, therefore between the step at the smallest size and the ladder leg forms a relatively large cavity, which will cause shaking during transportation, which will easily cause the deformation of the foldable ladder. Besides, when the steps are set with reserved folding spaces according to steps of different sizes, the spacing between the steps of each step gradually decreases from bottom to top, which is contrary to the conventional cognition of the operator and is prone to potential safety hazards.

### SUMMARY OF THE INVENTION

In order to overcome the above-mentioned defects in the prior art, the present invention provides a foldable ladder with stable structure during use and compact structure after being folded.

In order to achieve the above-mentioned purpose of the invention, the present invention adopts the following technical scheme: a foldable ladder, comprising two ladder frames rotatably connected at the top, and the ladder frames all include two ladder legs arranged in parallel, and several steps are arranged between the two parallel ladder legs; wherein a pair of frame hinge assemblies are arranged between the two ladder frames, and the pair of frame hinge assembly are relatively arranged on the two ladder legs of the ladder frame; a balancing member are provided on the frame hinge assembly, one end of the balancing member is hinged with one frame hinge assembly, and the other end of the balancing member is connected with another frame hinge assembly in a locking manner; the frame hinge assembly includes a connected frame hinge outer assembly and a frame hinge inner assembly; the ladder leg is further provided with a locking device for the balancing member.

As a preferred solution of the present invention, the frame hinge outer assembly and the frame hinge inner assembly are rotatably connected, and the frame hinge outer assembly and the frame hinge inner assembly are respectively arranged on two adjacent ladder legs, so that the two adjacent ladder legs of the two ladder frames are respectively connected to form a left leg frame and a right leg frame; each step is formed by a left step section and a right step section hingedly connected with each other, and the ends of the left step section and the right step section are rotatably connected with the ladder legs.

As a preferred solution of the present invention, the ladder legs have a plurality of support portions at different heights, and the two ends of each step are respectively connected to the left leg frame and the right leg frame on the corresponding support portions; wherein the lengths of at least two steps are substantially the same so that the left leg frame and the right leg frame are arranged in parallel, and the middle part of each step is provided with a bendable structure; the two ends of each step are hinged with the left leg frame and the right leg frame respectively;
when the step is in the unfolded state, the two ends of the step are respectively abutted against the left leg frame and the right leg frame;
when the step is in a folded state, the surface of the step is respectively abutted against the left leg frame and the right leg frame;
the top of the right leg frame is provided with a balancing member that is detachably connected to the top of the left leg frame; the middle of the steps is provided with a step pivot shaft connecting with the bendable structures of the steps.

As a preferred solution of the present invention, the tops of both ends of the step are formed with snap-fit notches, the two step sections of each step (3) are respectively rotatably connected with the corresponding support portions (8); when the step is in the unfolded state, the connection between the bottom of the snap-fit notch and the step is at the same level with the center of the adjacent support portion, and the extension lines of the two adjacent ladder legs of the left leg frame or the right leg frame are arranged crosswise, and the frame hinge assembly is arranged at the intersection of the two adjacent ladder legs, and between the adjacent ladder legs of both the left leg frame and the right leg frame are each provided with a limit pull rod with a bendable structure.

As a preferred solution of the present invention, the step pivot shaft connects all steps on the same ladder frame, and the left step section and the right step section are provided with connected support shafts, and the support shafts pass through the corresponding step pivot shafts.

As a preferred solution of the present invention, when the left step section and the right step section are in the unfolded state, adjacent ends are abutted, and the left step section and the adjacent ends of the right step section are formed with fitting grooves which are adapted to the step pivot shaft. The left step section and the right step section are in a staggered arrangement, the left step section and the right step section are each formed with a notch groove on one of the two side walls for easy rotation, and the top of the step pivot shaft is provided with a pull ring; the top of the step pivot shaft is flush with the surface of the uppermost step when the step is in use; the left leg frame and the right leg frame are each provided with a handle in the corresponding middle.

As a preferred solution of the present invention, one end of the balancing member is rotatably connected to a lock, the frame hinge assembly which is in locking connection with one end of the balancing member is provided with a matching double-diameter rivet shaft thereon, and the lock is matched with the frame hinge assembly.

As a preferred solution of the present invention, the locking device comprises a press buckle, a spring and a third rivet shaft, the spring and the press buckle is sleeved on the third rivet shaft, and the spring is in contact with the outer side of the press buckle, and the ladder leg is formed with a connecting hole adapted to the third rivet shaft; the frame hinge outer assembly and the frame hinge inner assembly are rotatably connected by a double-diameter rivet shaft.

As a preferred solution of the present invention, downwardly protruding limit bars are oppositely provided under the balancing member, the top of each frame hinge assembly is provided with two raised limit stands, and the length of the limit bar is equal to the distance between the two limit stands (28) on the frame hinge assembly, and the outer side of the limit bar is in contact with the inner side of the frame hinge assembly.

As a preferred solution of the present invention, the balancing component (5) is a tool tray, and the tool tray is formed with several small lattices and holes of different sizes and shapes.

As a preferred solution of the present invention, two pivot brackets are formed alongside one end of the balancing member, and between the two pivot brackets are provided with a multi-axis hinge connected to the frame hinge assembly.

As a preferred solution of the present invention, the multi-axis hinge comprises a hinge and a limit piece that are rotatably connected, and the hinge is formed with a first shaft hole that communicates with the pivot bracket, and a first rivet shaft is arranged in the first shaft hole, and the limit piece is rotatably connected to the frame hinge assembly, and a second shaft hole and an arc-shaped hole are formed on the limit piece, and the second shaft hole is provided with a double-diameter rivet shaft that passes through the limit piece, the frame hinge outer assembly and the frame hinge inner assembly in sequence, and the frame hinge outer assembly is formed with a round hole communicating with the arc-shaped hole, and the arc-shaped hole is provided with a limit rivet connected to the round hole.

As a preferred solution of the present invention, the other end of the balancing member is provided with a lock catch and a second rivet shaft passing through the lock catch, and the balancing member is formed with a matching hole that is adapted to the second rivet shaft, the lock is rotatably connected to the end of the balancing member, and the lock is adapted to the frame hinge assembly.

As a preferred solution of the present invention, downwardly protruding limit bars are oppositely provided under the balancing member, the top of the frame hinge assembly is provided with two raised limit stands, and the length of the limit bar is equal to the distance between the two limit stands on the frame hinge assembly, and the outer side of the limit bar is in contact with the inner side of the frame hinge assembly.

As a preferred solution of the present invention, the supporting legs have a plurality of support portions at different heights, and the two ends of each step are respectively connected to the left leg frame and the right leg frame on the corresponding support portions; wherein the lengths of at least two steps are substantially the same so that the left leg frame and the right leg frame are arranged in parallel, and the middle part of each step is provided with a bendable structure; the two ends of each step are hinged with the left leg frame and the right leg frame respectively;
wherein when the step is in the unfolded state, the two ends of the step are respectively abutted against the left leg frame and the right leg frame;
wherein when the step is in a folded state, the surface of the step is respectively abutted against the left leg frame and the right leg frame;
the top of the right leg frame is provided with a balancing member that is detachably connected to the top of the left leg frame; the middle of the steps is provided with a step pivot shaft connecting with the bendable structures of the steps.

As a preferred solution of the present invention, the tops of both ends of the step are formed with snap-fit notches; the two step sections of each step (3) are respectively rotatably connected with the corresponding support portions (8); when the step is in the unfolded state, the connection between the bottom of the snap-fit notch and the step is at the same level with the center of the adjacent support portion, and the extension lines of the two adjacent ladder legs of the left leg frame or the right leg frame are arranged crosswise, and the frame hinge assembly is arranged at the intersection of the two adjacent ladder legs, and between the adjacent ladder legs of both the left leg frame and the right leg frame are each provided with a limit pull rod with a bendable structure.

As a preferred solution of the present invention, the step pivot shaft connects all steps on the same ladder frame, and the left step section and the right step section are provided with connected support shafts, and the support shafts pass through the corresponding step pivot shafts.

As a preferred solution of the present invention, when the left step section and the right step section are in the unfolded state, adjacent ends abut against each other, and the adjacent ends of the left step section and the right step section step section are formed with fitting grooves which are adapted to the step pivot shaft; the left step section and the right step section are arranged alternately, and the left step section and the right step section are each formed with a notch groove on one of the two side walls for easy rotation; a pull ring is provided at the top of the step pivot, and when the step is in use, the top of the step pivot is flush with the surface of the uppermost step; a handle is provided in each middle portions of the left leg frame and the right leg frame.

Compared with the prior art, the beneficial effects of the present invention includes:
1. By setting snap-fit notches at both ends of the steps, the steps do not collide with the ladder legs during the rotation process, and at the same time, the steps in the unfolded state and the folded state are in contact with the ladder legs, making the overall structure compact and with better anti-vibration performance, and easy to transport the whole foldable ladder;
2. By arranging a detachable balancing member on the top of the left leg frame and the right leg frame, when the left leg frame and the right leg frame are unfolded, the left leg frame and the top of the right leg frame can be connected through the balancing member, so that the whole ladder has better stability in unfolded state;
3. A fitting groove is formed on the step to match the step pivot shaft, and the support shaft in the middle of the step is set through the step pivot shaft, so that all steps in the same ladder frame form a whole under the action of the step pivot shaft, which is convenient for the steps in the same ladder frame operate synchronously, and facilitate the force transmission of the steps in the same ladder frame;
4. The left step section and the right step section of the steps are staggered, and the left step section and the right step section are each formed with a notch groove on one of the two side walls for easy rotation, which can guide the left step section and the right step section during the rotation process. It has a better contact area when the left step section and the right step section are in the folded state, and result in a better shockproof effect, which is convenient for the transportation of the whole foldable ladder;
5. To sum up the above 1, 2, 3, and 4, the ladder legs of the left leg frame and the right leg frame are arranged in parallel, so that the steps between the ladder legs are the same size, which is convenient for the mass production of steps during the production process, and also it is convenient for the connection and installation between the subsequent steps and the ladder legs, and has better economy;
6. By setting a reversible balancing member on the top of the ladder, when the ladder is unfolded, the reversible balancing member can place the tool tray on the ladder, and the balancing member is provided with a lock detachably connected to the ladder, so that the balancing member has better stability on the ladder; at the same time, during storage, the ladder legs are provided with a locking device adapted to the balancing member, so that the balancing member has good stability after storage.

### BRIEF DESCRIPTION OF THE DRAWINGS

FIG. 1 is a structural schematic view of the present invention;

FIG. 2 is a schematic diagram of the unfolded state of the present invention;

FIG. 3 is a partial enlarged view of place A in FIG. 2;

FIG. 4 is a schematic diagram of the folded state of the present invention;

FIG. 5 is a schematic diagram of the connection of the step and the ladder leg;

FIG. 6 is a schematic diagram of the unfolded state of the step and the ladder leg;

FIG. 7 is a schematic diagram of the folded state of the step and the ladder leg;

FIG. 8 is a schematic diagram of the connection between the step and the step pivot shaft;

FIG. 9 is a partial enlarged view of place A in FIG. 8;

FIG. 10 is a schematic diagram of the connection between the ladder leg and the hinge device;

FIG. 11 is the connection schematic diagram of the left leg frame, the right leg frame and the balancing member;

FIG. 12 is a schematic diagram of the connection between the left step section and the right step section;

FIG. 13 is an exploded view of the tool tray;

FIG. 14 is a schematic diagram of the connection of the frame hinge assembly;

FIG. 15 is a schematic diagram of the connection between the frame hinge assembly and the multi-axis hinge;

FIG. 16 is a schematic diagram of the connection between the balancing member and the frame hinge assembly;

FIG. 17 is a schematic diagram of the hinged connection between the balancing member and the frame hinge assembly;

FIG. 18 is a schematic diagram of the locking connection between the balancing member and the frame hinge assembly;

FIG. 19 is a schematic diagram of the limit position of the balance component on the multi-axis hinge;

FIG. 20 is another schematic diagram of the limit position of the balance component on the multi-axis hinge;

FIG. 21 is a schematic diagram of the connection of the locking device;

FIG. 22 is a schematic diagram of the use state of the tool tray;

FIG. 23 is a schematic diagram of the disassembly state of of the tool tray;

FIG. 24 is a schematic diagram of the storage state of the tool tray.

### NOTES

left leg frame 1, right leg frame 2, step 3, left step section 3-1, right step section 3-2, fitting groove 3-3, notch groove 3-4, step pivot shaft 4, support shaft 4-1, pull ring 4-2, balancing member 5, limit pull rod 6, handle 7, support portion 8, snap-fit notch 9, ladder leg 10, frame hinge assembly 14, frame hinge outer assembly 14A, outer assembly shaft hole 14A-1, round hole 14A-2, frame hinge inner assembly 14B, inner assembly shaft hole 14B-1, pivot bracket 15, multi-axis hinge 16, first shaft hole 16-1, second shaft hole 16-2, arc-shaped hole 16-3, first rivet shaft 17, double-diameter rivet shaft 18, first isolation washer 19, first process washer 20, limit rivet 21, matching hole 22, second rivet shaft 23, lock catch 24, second isolation washer 25, second process washer 26, limit bar 27, limit stand 28, connection hole 29, third rivet shaft 30, spring 31, pressure buckle 32, third isolation washer 33, and recess 34.

### DETAILED DESCRIPTION OF THE INVENTION

The embodiments of the present invention will be described in detail below with reference to the accompanying drawings.

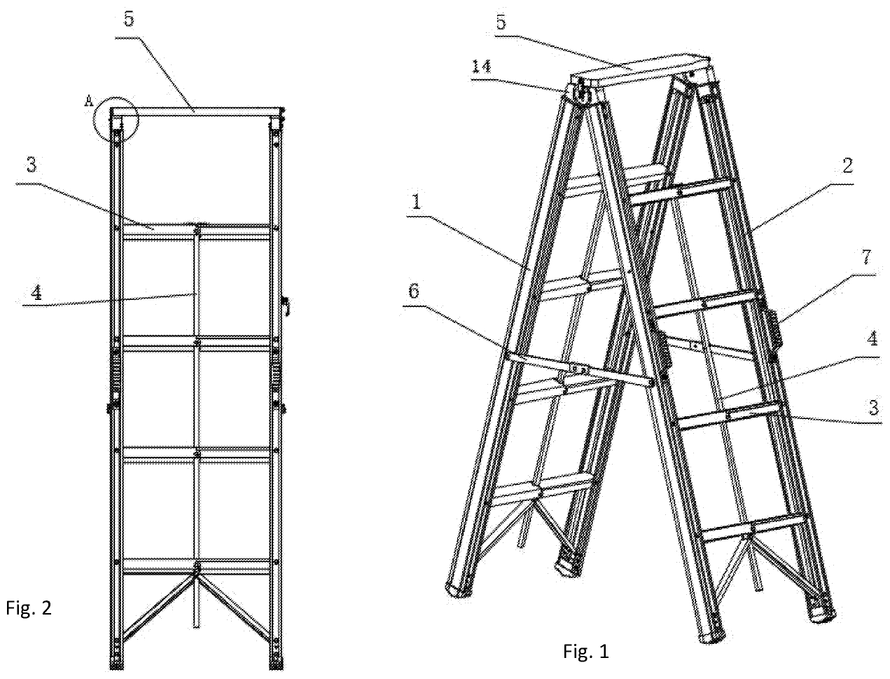

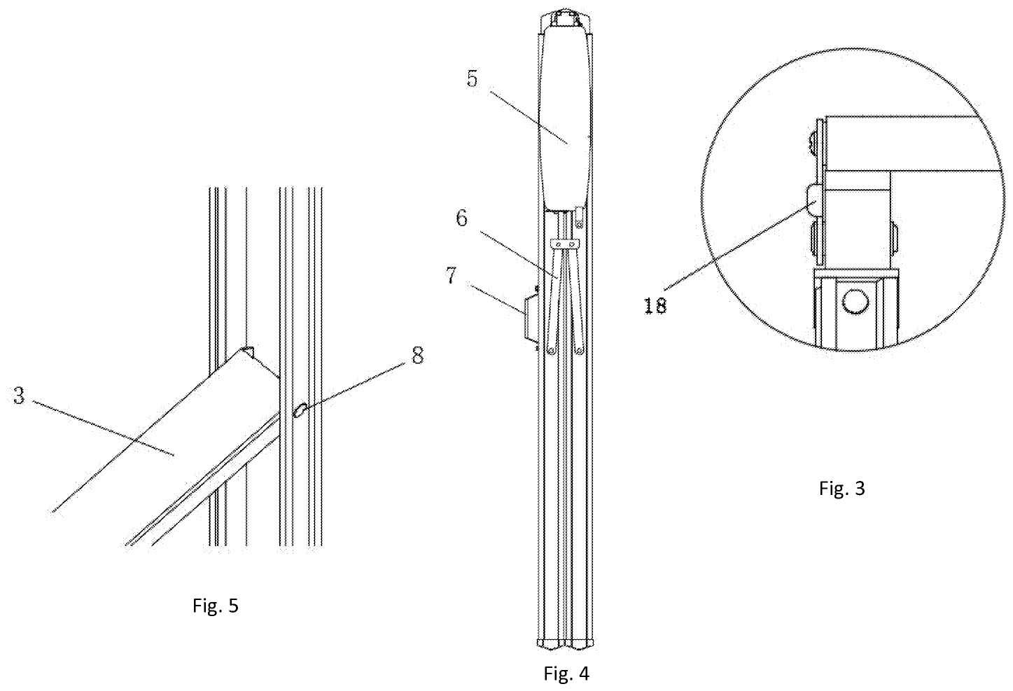

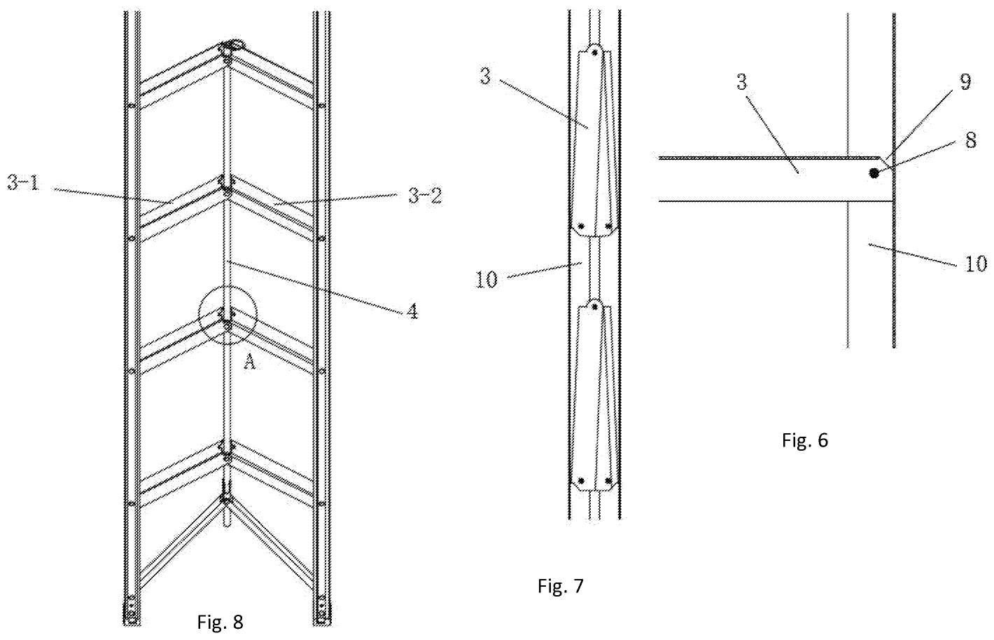

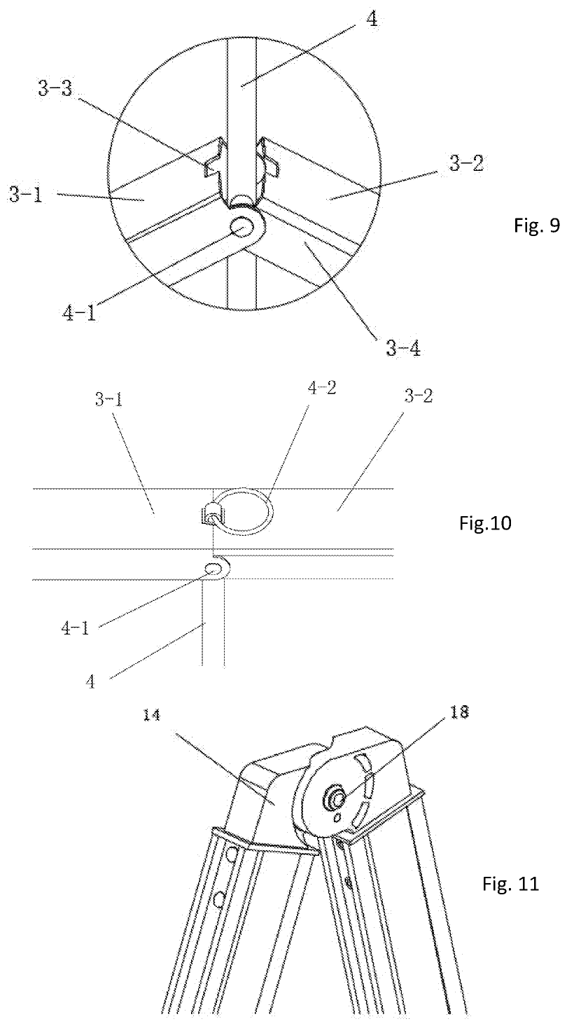

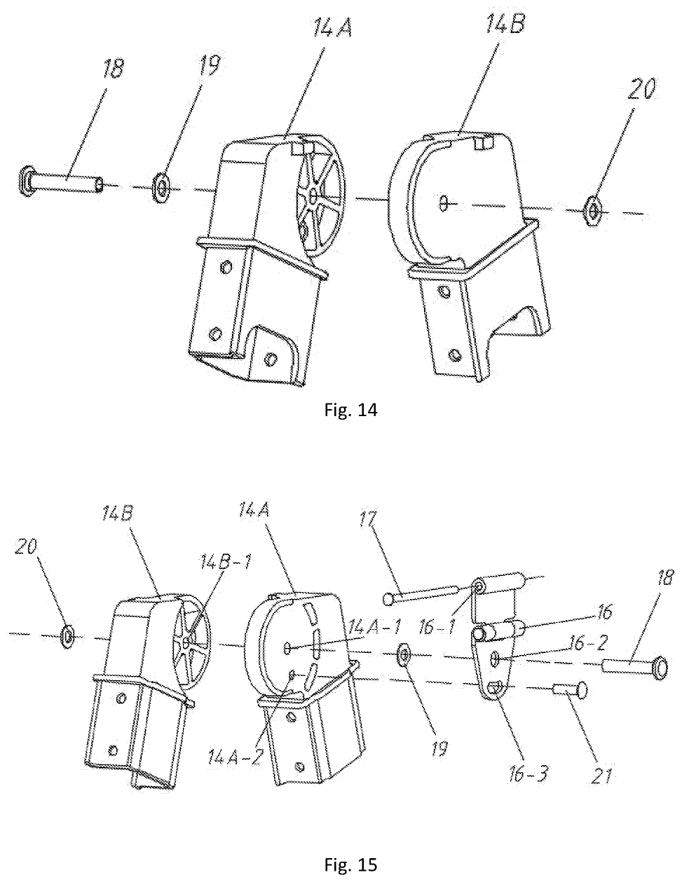

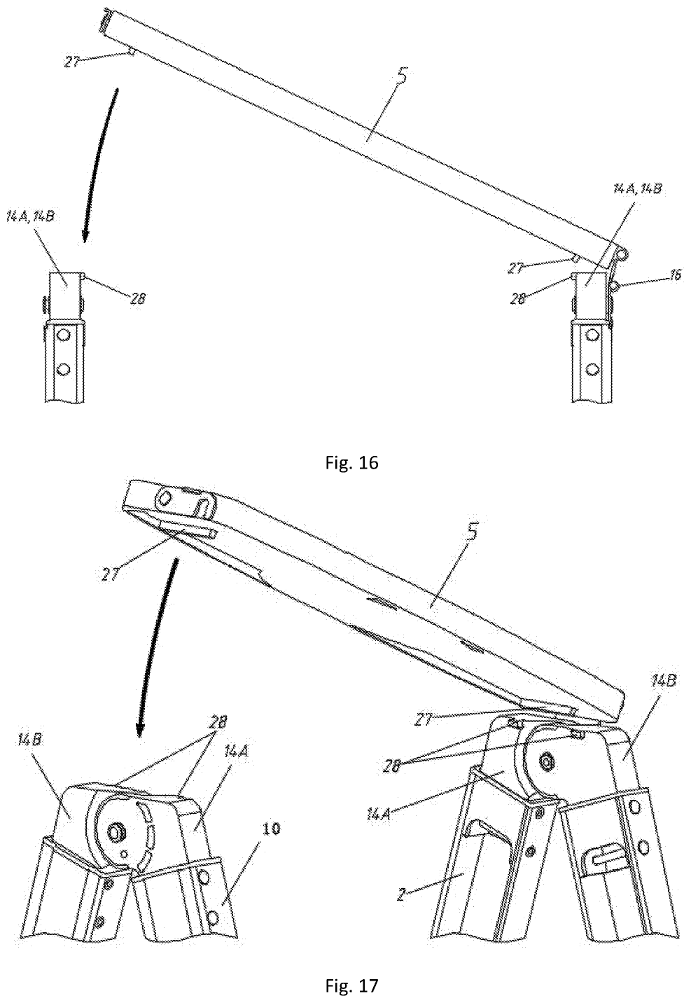

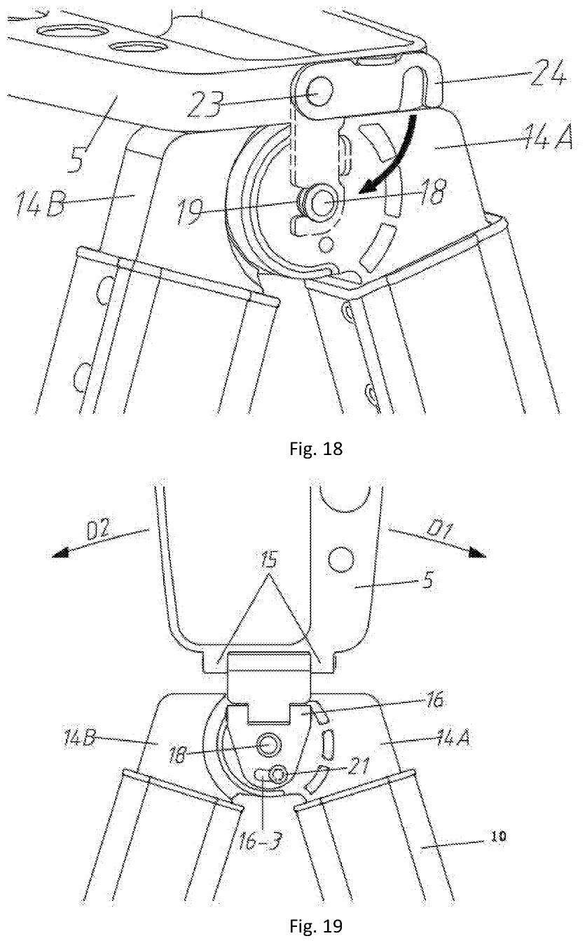

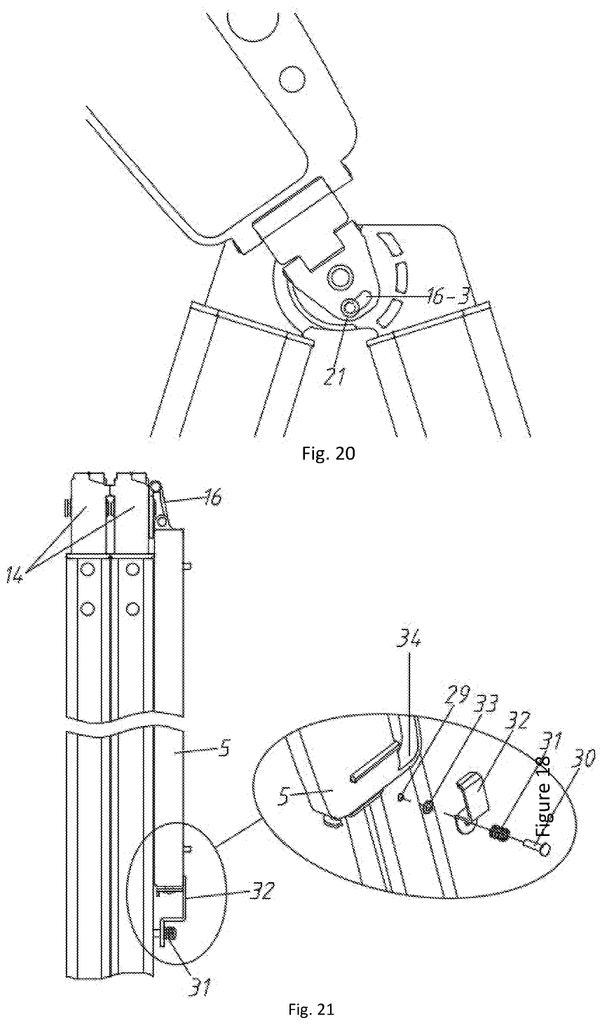

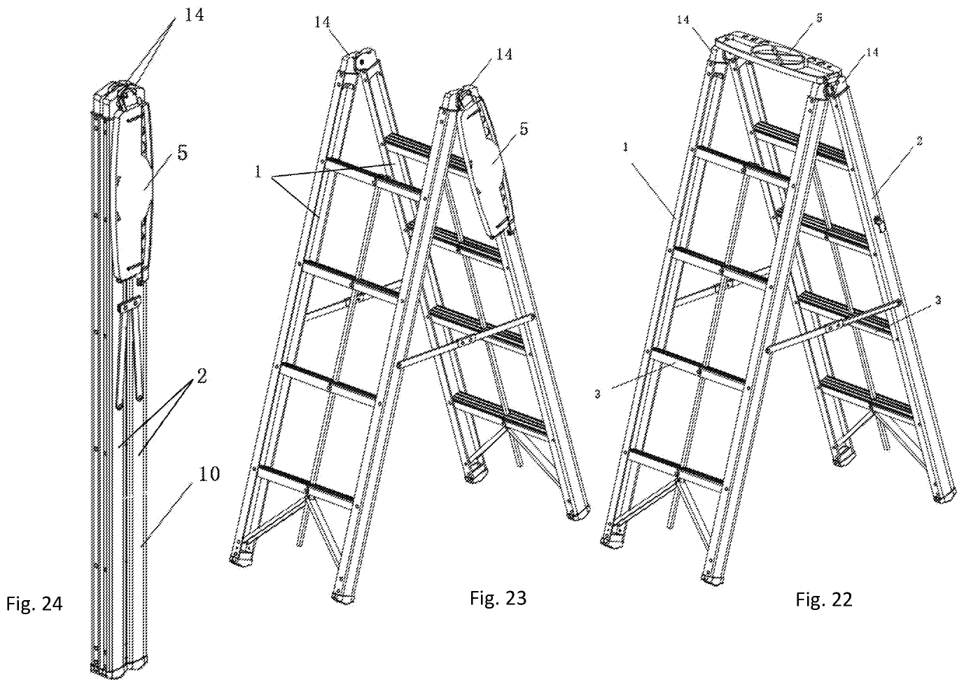

As shown in FIGS. 1-24, foldable ladder comprises two ladder frames rotatably connected at the top, and the ladder frames all include two ladder legs 10 arranged in parallel, and several steps 10 are arranged between the two parallel ladder legs 10; wherein a pair of frame hinge assemblies 14 are arranged between the two ladder frames, and the pair of frame hinge assembly 14 are relatively arranged on the two ladder legs 10 of the ladder frame; a balancing member 5 are provided on the frame hinge assembly 14, one end of the balancing member 5 is hinged with one frame hinge assembly 14, and the other end of the balancing member 5 is connected with another frame hinge assembly 14 in a locking manner; the frame hinge assembly 14 includes a connected frame hinge outer assembly 14A and a frame hinge inner assembly 14B; the ladder leg 10 is further provided with a locking device for the balancing member 5.

The frame hinge outer assembly 14A and the frame hinge inner assembly 14B are rotatably connected, and the frame hinge outer assembly 14A and the frame hinge inner assembly 14B are respectively arranged on two adjacent ladder legs 10, so that the two adjacent ladder legs of the two ladder frames are hinged by a frame hinge assembly 14 to form a left leg frame 1 and a right leg frame 2; each step 3 is formed by a left step section 3-1 and a right step section 3-2 hingedly connected with each other, and the ends of the left step section 3-1 and the right step section 3-2 are rotatably connected with the ladder legs 10.

The ladder legs 10 have a plurality of support portions 8 at different heights, and the two ends of each step 3 are respectively connected to the left leg frame 1 and the right leg frame 2 on the corresponding support portions 8; wherein the lengths of at least two steps 3 are substantially the same so that the left leg frame 1 and the right leg frame 2 are arranged in parallel, and the middle part of each step 3 is provided with a bendable structure; the two ends of each step 3 are hinged with the left leg frame 1 and the right leg frame 2 respectively;

when the step 3 is in the unfolded state, the two ends of the step 3 are respectively abutted against the left leg frame 1 and the right leg frame 2;

when the step 3 is in a folded state, the surface of the step 3 is respectively abutted against the left leg frame 1 and the right leg frame 2;

the top of the right leg frame 2 is provided with a balancing member 5 that is detachably connected to the left leg frame 1; the middle of the steps 3 is provided with a step pivot shaft 4 connecting with the bendable structures of the steps 3. The tops of both ends of the step 3 are each formed with a snap-fit notche 9.

The number of steps 3 is set according to actual needs. The two ladder legs 10 of each ladder frame are arranged in parallel, so that the sizes of the steps 3 between the two ladder legs 10 are the same, and the multi-step steps 3 are arranged on the two ladder legs 10 at different heights. The support portion 8 can be a pivot connected to the ladder leg 10, and each end portion of the step 3 is rotatably connected to the support portion 8. With the support portion 8 as the center of the circle, the rotation of the end portion of the step 3 on the ladder leg 10 can be realized. Since the middle of the step 3 is provided with a bendable structure, during the rotation of the step 3, the distance between the two ladder legs 10 changes, thereby realizing the folding operation of the left leg frame 1 or the right leg frame 2.

The ladder legs 10 are of a trough structure until the inner sides of the two ladder legs 10 of the left leg frame 1 or the right leg frame 2 are in contact. At this time, the step 3 is arranged on the inner side of the ladder legs 10 of the trough structure, so that the wrapping folding of the steps 3 is realized under the action of the two ladder legs 10.

The snap-fit notch 9 is a chamfered or rounded structure. When the step 3 is in the unfolded state, the two ends of the step 3 are respectively abutted against the left leg frame 1 and the right leg frame 2, and the left leg frame 1 and the right leg frame 2 are angled, respectively, and the steps 3 are in a horizontal state and are vertically arranged with both the left leg frame 1 and the right leg frame 2; when the step 3 is in a folded state, the surface of the step 3 is in contact with the left leg frame 1 and the right leg frame 2 respectively. The two ladder frames are arranged in parallel, and each step 3 is arranged in parallel with the left leg frame 1 and the right leg frame 2, and is wrapped in the left leg frame 1 and the right leg frame 2. and the step 3 is in the unfolded state. When switching between the folded states, due to the existence of the snap-fit notches 9, the rotation of the step 3 does not collide with the ladder legs 10.

The top of the right leg frame 2 is provided with a balancing member 5 that is detachably connected to the top of the left leg frame 1; The frame hinge assemblies 14 on the leg frame 1 or the right leg frame 2 are connected, so that the top of the left leg frame 1 or the right leg frame 2 is connected. When the ladder is in the unfolded state, the steps between the left leg frame 1 or the right leg frame 2 pass through. 3 is connected with the balancing member 5, and at this time the step 3 is arranged in parallel with the balancing member 5 to realize the connection between the top and the middle of the left leg frame 1 or the right leg frame 2, so that there is a better stability between the left leg frame 1 and the right leg frame 2.

The top of the right leg frame 2 is provided with a balancing member 5 that is detachably connected to the top of the left leg frame 1; the middle of the steps 3 is provided with a step pivot shaft 4 connecting the bendable structures of the steps 3, and the balancing member 5 can be connected with the frame hinge assembly 14 on the left leg frame 1 or the right leg frame 2, thereby realizing connection between the tops of the left leg frame and the right leg frame. When the ladder is in the unfolded state, the left leg frame 1 or the right leg frame 2 is connected through the step 3 and the balancing member 5, and the step 3 and the balancing member 5 are arranged in parallel at this time, so that the tops and the middles of the left leg frame 1 and the right leg frame 2 are both connected, thus enabling better stability between the left leg frame 1 and the right leg frame 2.

The step pivot shaft 4 is always arranged in parallel with the ladder legs 10, and the step pivot shaft 4 is connected with all the corresponding steps 3, so that after one of the steps 3 rotates, all the steps 3 on the same side are synchronously driven to rotate, which is convenient for the steps 3 to expand and collapse.

The tops of both ends of the step 3 are each formed with a snap-fit notch 9, the two step sections of each step (3) are respectively rotatably connected with the corresponding support portions (8); when the step 3 is in the unfolded state, the connection between the bottom of the snap-fit notch 9 and the step 3 is at the same level with the center of the adjacent support portion 8.

The extension lines of the two ladder legs 10 of the left leg frame 1 or the right leg frame 2 are arranged crosswise, the frame hinge assembly 14 is arranged at the intersection of the two ladder legs 10, and a limit pull rod 6 which is a bendable structure arranged between the two ladder legs 10. The limit pull rod 6 is composed of three sections of rods connected in sequence, and there are connected rotating shafts between the adjacent rod members. When the three sections of rods are on the same straight line, the total length of the three sections of rods is the longest distance that the limit pull rod 6 can move, therefore, under the action of the limit pull rod 6, the maximum rotation angle of the left leg frame 1 and the right leg frame 2 is limited, and at the same time, the limit pull rod 6 forms a stable triangular structure with the left leg frame 1 or the right leg frame 2, respectively.

The balancing member 5 is connected to the frame hinge assembly 14 of the left leg frame 1 and the right leg frame 2, and one end of the balancing member 5 is hinged with the left leg frame 1 or the right leg frame 2, and the other end of the balancing member 5 is connected with the left leg frame 1 or the right leg frame 2. The leg frame 2 is clamped, and the left leg frame 1 or the right leg frame 2 clamped with the balancing member 5 is provided with a matching double-diameter rivet shaft 18.

The balancing member 5 is connected to the frame hinge assemblies 14 of the left leg frame 1 and the right leg frame 2, and one end of the balancing member 5 is hinged with the left leg frame 1 or the right leg frame 2, and the other end of the balancing member 5 is in locking connection with the right leg frame 1 or the left leg frame 2. The right leg frame 1 or the left leg frame 2 that is in locking connection with the balancing member 5 is provided with a matching double-diameter rivet shaft 18.

One end of the balancing member 5 is formed with a lock catch 24 that is adapted to the double-diameter rivet shaft 18, and the lock catch 24 is formed with a slot that is adapted to the double-diameter rivet shaft 18. By rotating the lock catch 24 to the double-diameter rivet shaft 18 is located in the card slot, realizes the connection between the lock catch 24 and the double-diameter rivet shaft 18, realizes the connection between the left leg frame 1 or the right leg frame 2 and the balancing member 5, so as to realize the top connection of the left leg frame 1 and the right leg frame 2.

One end of the balancing member 5 is formed with a lock catch 24 that is adapted to the double-diameter rivet shaft 18, and the lock catch 24 is formed with a slot that is adapted to the double-diameter rivet shaft 18. By rotating the lock catch 24 to the double-diameter rivet shaft 18 and locate the double-diameter rivet shaft 18 in the slot of the lock catch 24, the connection between the lock catch 24 and the double-diameter rivet shaft 18 is realized, thus realizing the connection between the left leg frame 1, the right leg frame 2 and the balancing member 5, so as to realize the connection of the left leg frame 1 and right leg frame 2 at their top.

The hinged end of the balancing member 5 is provided with a connected hinge and a limit piece, the hinge and the limit piece are connected by a rotating shaft, the hinge and the balancing member 5 are connected by a rotating shaft, and the middle part of the limit piece is rotatably connected with the frame hinge assembly 14 through the rotating shaft. And the limit piece is formed with an arc-shaped hole for position-limiting, and the frame hinge assembly 14 is formed with a round hole communicating with the arc-shaped hole.

During use, the limit piece is always attached to the side of the frame hinge assembly 14, and the hinge is turned over and arranged on the top of the frame hinge assembly 14, so that under the action of the hinge and the limit piece, it is simultaneously in contact with the side and top of the frame hinge assembly 14, so that the balancing member 5 has better stability.

There are connected limit rivets in the arc hole and the round hole. The arc hole is set with the rotating shaft in the middle of the limit piece as the center. The limit piece can be rotated centered on the central shaft. When the limit rivet moves to both ends of the arc-shaped hole, the rotation angle of the limit piece is limited, so that the balancing member 5 can be rotated properly, which is convenient for the press buckle setting at the other end of the balancing member 5.

The steps 3 are arranged on the parallel ladder legs 10 of the ladder frame, and the step pivot shaft 4 is connected to all the steps 3 on the same ladder leg 10, so as to drive all the steps 3 to move synchronously under the action of the step pivot shaft 4, and all the steps 3 connected to the step pivot shaft 4 have better synchronization and connectivity. During use, when the steps 3 are in the unfolded state, the step pivot shaft 4 can play a certain force transmission role, so that the overall steps 3 have better resistance. And when the steps 3 are in a folded state, the step pivot shaft 4 can ensure that all the steps 3 connected are in a folded state, preventing collision with the ladder legs 10 during transportation.

The step 3 is composed of the left step section 3-1 and the right step section 3-2 which are rotatably connected, and a supporting shaft 4-1 connected between the left step section 3-1 and the right step section 3-2 is provided. The support shaft 4-1 passes through the corresponding step pivot shaft 4, and the left step section 3-1 and the right step section 3-2 are connected by rotation through the support shaft 4-1, and the step pivot shaft 4 drives the support shaft during the movement process 4-1, so as to realize the synchronous movement of all the connected supporting shafts 4-1, and realize the synchronous movement of all the connected steps 3.

When the steps 3 are in the unfolded state, the support shaft 4-1 is in an overhead form and is in a stressed state. Under the action of the step pivot shaft 4, the corresponding support shafts 4-1 of all the steps 3 are connected to the step pivot shaft, which can transmit the force on the support shaft 4-1, and can also support the support shaft 4-1, so that the whole has better stability.

When the left step section 3-1 and the right step section 3-2 are in the unfolded state, the adjacent ends are in contact with each other, and the adjacent ends of the left step section 3-1 and the right step section 3-2 are each formed with a fitting groove 3-3 matched with the step pivot shaft 4, making the left step section 3-1 and the right step section 3-2 have a larger contact area with the step pivot shaft 4 under the action of the fitting groove 3-3, so that the step pivot shaft 4 has better stability during use, and is evenly stressed.

The left step section 3-1 and the right step section 3-2 are staggered, and the left step section 3-1 and the right step section 3-2 are each formed with a notch groove 3-4 on one of the two side walls for easy rotation, which is convenient for the staggered rotation of the left step section 3-2 and the right step section 3-2, making the left step section 3-1 and the right step section 3-2 have better contact area and stability during the rotation.

The left side notch groove 3-4 is located on the side of the left step section 3-1, and the left side notch groove 3-4 is arranged along the length direction of the bottom of the left step section 3-1, and the right side notch groove 3-4 is located on the other side of the right step section 3-2 relative to the left step section 3-1, similarly, the right side notch groove 3-4 is arranged along the length direction of the bottom of the right step section 3-2.

Under the action of the notch grooves 3-4, during the rotation process of the left step section 3-1 and the right step section 3-2, one side of the left step section 3-1 side is moving in the notch groove 3-4 of the right step section 3-2; and similarly, one side of the right step section 3-2 moves in the notch groove 3-4 of the left step section 3-1, the inner wall of one side of the left step section 3-1 side is in contact with the outside of corresponding side of the right step section 3-2, and the outside of another side of the left step section 3-1 side is in contact with the inner wall of corresponding side of the right step section 3-2. During the rotation of the left step section 3-1 and the right step section 3-2, the left step section 3-1 and the right step section 3-2 always partially overlap.

The top of the step pivot shaft 4 is provided with a pull ring 4-2. When the step 3 is in use, the top of the step pivot shaft 4 is flush with the surface of the uppermost step 3 to prevent the top of the step pivot shaft 4 from interfering with the step 3. The pulling of the pull ring 4-2 drives the movement of the step pivot shaft 4, and the pull ring 4-2 can play the role of manually driving the step pivot shaft 4 to move.

The middle parts of the left leg frame 1 and the right leg frame 2 are each provided with a corresponding handle 7. When the left leg frame 1 and the right leg frame 2 are in the folded state, the whole ladder can be lifted by the handle 7, which is convenient for portable transportation of the ladder.

### Example 1

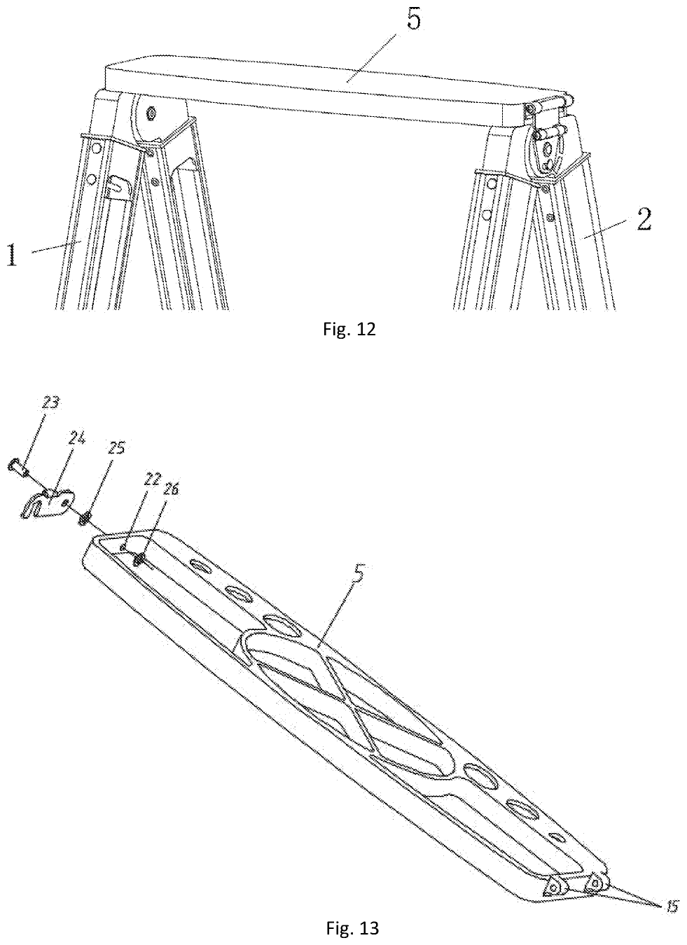

As shown in FIGS. 12-24, the foldable ladder disclosed by this example comprises two ladder frames rotatably connected at the top, and the ladder frames all include two ladder legs 10 arranged in parallel, and several steps 10 are arranged between the two parallel ladder legs 10; wherein a pair of frame hinge assemblies 14 are arranged between the two ladder frames, and the pair of frame hinge assembly 14 are relatively arranged on the two ladder legs 10 of the ladder frame; a balancing member 5 are provided on the frame hinge assembly 14, the balancing component 5 is a tool tray, and the tool tray is formed with several small lattices and holes of different sizes and shapes for holding parts and inserting tools.

One end of the balancing member 5 is hinged with one frame hinge assembly 14, and the other end of the balancing member 5 is connected with another frame hinge assembly 14 in a locking manner; the frame hinge assembly 14 includes a connected frame hinge outer assembly 14A and a frame hinge inner assembly 14B; the ladder leg 10 is further provided with a locking device for the balancing member 5.

The frame hinge outer assembly 14A and the frame hinge inner assembly 14B are rotatably connected, and the frame hinge outer assembly 14A and the frame hinge inner assembly 14B are respectively connected to the adjacent left leg frame 1 and right leg frame 2. Each step 3 comprises a left step section 3-1 and a right step section 3-2 that are hingedly connected. The ends on both sides of the left step section 3-1 and the right step section 3-2 are rotatably connected with the ladder legs 10. The number of steps 3 is set according to actual needs, and both ends and the middle part of each step 3 can be rotated upward, and when the step 3 is horizontal, the bottoms of the two left step section 3-1 and the right step section 3-2 touch each other, thereby realizing the limit of the step 3.

Alongside one end of the balancing member 5 is formed with two pivot brackets 15, and a multi-axial hinge 16 connected with the frame hinge assembly 14 is arranged between the two rotating shaft brackets 15, and the multi-axial hinge 16 includes a rotating connection. A first shaft hole 16-1 communicated with the rotating shaft bracket 15 is formed on the flip sheet, and a first rivet shaft 17 is arranged in the first shaft hole 16-1, and the limit piece is rotatably connected to the frame hinge assembly 14.

The first rivet shaft 17 passes through the shaft hole of one of the pivot brackets 15, the first shaft hole 16-1 of the multi-shaft hinge 16 and the shaft hole of the other shaft bracket 15 in sequence, and then riveted and hinged, so that the balancing member 5 is rotatably connected with the flip sheet using the first rivet shaft 17 as the shaft.

A second shaft hole 16-2 and an arc-shaped hole 16-3 are formed on the limit piece, and the second shaft hole 16-2 is provided with a double-diameter rivet shaft that passes through the limit piece, the outer frame hinge assembly and the frame hinge inner assembly in sequence, and the frame hinge outer assembly is formed with a round hole 14A-2 communicating with the arc-shaped hole 16-3, and the arc-shaped hole 16-3 is provided with a limit rivet 21 connected to the round hole 14A-2.

A first isolation washer 19 is provided between the frame hinge outer assembly 14A and the limit piece, a first process washer 20 is provided on the outer side of the frame hinge inner assembly 14B, and the double-diameter rivet shaft 18 passes through the second shaft hole 16-2 of the multi-axis hinge 16, the first isolation washer 19, the outer assembly shaft hole 14A-1 of the frame hinge outer assembly 14A, the inner assembly shaft hole 14B-1 of the frame hinge inner assembly 14B, and the first process washer 20 in sequence, then riveted and hinged; wherein after the large-diameter part of the double-diameter rivet shaft 18 only passes through the second shaft hole 16-2 of the multi-axis hinge 16, the step of the pedal between the large-diameter part and the small-diameter part abuts on the plane of the first isolation washer 19, the small diameter part passes through the first isolation washer 19, the frame hinge outer assembly 14A, the frame hinge inner assembly 14B and the first process washer 20 in sequence.

The limiting rivets 21 pass through the arc-shaped holes 16-3 on the multi-axis hinge 16 and the round hole 14A-2 on the frame hinge outer assembly 14A in sequence and are riveted movably. Taking the double-diameter rivet shaft 18 as the axis, due to the cooperation between the limit rivet 21 and the arc-shaped hole 16-3, the balancing member 5 cannot be rotated in the direction of D1, and the range of rotation in the D2 direction will be limited by the arc-shaped hole 16-3. The position of the balancing member 5 is the maximum limit position of rotation in the D2 direction, but the rotation range required for the balancing member 5 to be fixed on the left leg frame 1 or the right leg frame 2 when stored is within the allowable rotation range in the D2 direction.

On the top of the other side of the ladder, there is also a double-diameter rivet shaft 18 which passes through the first isolation washer 19, the shaft hole 3A-1 of the frame hinge outer assembly 14A, and the shaft hole 14B-1 of the inner assembly of the frame hinge inner assembly 14A, the first process washer 20 and then riveted and hinged, wherein the step bar steps between the large-diameter part and the small-diameter part of the double-diameter rivet shaft 18 are in contact with the plane of the first isolation washer 19, and the small-diameter part passes through the first isolation gasket 19, frame hinge outboard assembly 14A, frame hinge inboard assembly 14B, and first process gasket 20 in turn.

The other end of the balancing member 5 is provided with a lock catch 24 and a second rivet shaft 23, the second rivet shaft 23 is disposed through the lock catch 24, and the balancing member 5 is formed with a matching hole 22 that matches the second rivet shaft 23, The lock catch 24 is rotatably connected to the end of the balancing member 5, and the lock catch 24 is adapted to the frame hinge assembly 14.

A matching hole 22 is provided at the other end of the balancing member 5, and the second rivet shaft 23 passes through the lock catch 24, the second isolation washer 25, the matching hole 22, and the second process washer 26 in sequence, and then movably riveted. The process effect after the movable riveting is as follows: the lock catch 13 can be rotated radially by pulling it by hand, but it will not move in the axial direction, nor will it rotate radially when there is no external force.

Below the balancing member 5, there are oppositely arranged limit bars 27 that protrude downward. The frame hinge outer assembly 14A and the frame hinge inner assembly 14B are each provided with a raised limit stand 28. The limit bars 27 are narrow and elongated. The limit stands 28 are located inside and below the top platform of the frame hinge outer assembly 14A and the frame hinge inner assembly 14B. The length of the limit bar 27 is equal to the distance between the two limit stands 28 on the frame hinge assembly 14, and the outer side of the limit bar 27 is in contact with the inner side of the frame hinge assembly.

Flipping and unfolding the balancing member 5, when the bottom surface of the balancing member 5 is in contact with the top plane of the frame hinge assembly 14, each limit bar 27 arranged under the balancing member 5 will enter the two limit stands located on the frame hinge outer assembly 14A and the frame hinge inner assembly 14B separately, thereby restricting the movement of the balancing member 5 in the front and rear directions, so that the two ends of each limit bar 27 are respectively connected with the limit stands located on the frame hinge outer assembly 14A and the frame hinge inner assembly 14B.

At the same time, the outer side surface of the limiting bar 27 is also in contact with the inner side surface of the frame hinge inner assembly 14B, so the movement of the balancing member 5 in the longitudinal direction is also restricted at the same time.

After the balancing member 5 is unfolded in place, manually pull the lock catch 24 into the large diameter portion of the double-diameter rivet shaft 18 between the double-diameter rivet shaft 18 and the first isolation washer 19, thereby restricting the upper and lower parts of the balancing member 5; at this time, the movement in the front, rear, left, right, up and down directions of the balancing member 5 have been restricted, so the stability and reliability of the tool tray in use are ensured.

The locking device includes a press buckle 32, a spring 31 and a third rivet shaft 30. The spring 31 and the press buckle 32 are sleeved on the third rivet shaft 30, and the spring 31 is in contact with the outer side of the press buckle 32. The leg 10 is form with a connecting hole 29 adapted to the third rivet shaft 30.

The locking device includes a connecting hole 29 provided on one of the ladder legs on the same side of the frame hinge assembly 14 that actively riveted with multi-axis hinge 16, and the third rivet shaft 30 passes through the spring 31 and the round hole on the press buckle 32, the third isolation washer 33 and the connecting hole 29 in turn, and then are fixed and riveted.

One end of the spring 31 is in contact with the head of the third rivet shaft 30, and the other end is in contact with the plane of the press buckle 32 with the round hole. The buckle 32 can be moved in the axial and radial directions of the rivet shaft 20 by pulling the spring 31 with finger. When the balancing member 5 is stored, one side of the grid on the balancing member 5 is close to the ladder leg 10, then use your fingers to hook and pull the buckle 32 and press the other end of the buckle 32 with the round hole into the balancing member 5 The recess 34 provided below, at this time, by means of the pressure of the spring 31 and the action of the buckle 32, the balancing member 5 is fixed on the ladder leg 10 by the pressure buckle. When the balancing member 5 is stored, the side of the balancing member 5 with the lattice is close to the ladder leg 10, and then the press buckle 32 is pulled with fingers and the other end with the round hole of the press buckle 32 is pressed into the recess provided at the bottom of the balancing member 5. At this time, by means of the pressure of the spring 31 and the action of the buckle 32, the balancing member 5 is buckled and fixed on the ladder leg 10.

The above description of the disclosed embodiments enables any person skilled in the art to make or use the present invention. Various modifications to these embodiments will be readily apparent to those skilled in the art, and the general principles defined herein may be implemented in other embodiments without departing from the spirit or scope of the invention; thus, the present invention is not to be limited to the embodiments shown herein, but is to be accorded the widest scope consistent with the principles and novel features disclosed herein.

Although this article uses terms and reference numerals as: left leg frame 1, right leg frame 2, step 3, left step section 3-1, right step section 3-2, fitting groove 3-3, notch groove 3-4, step pivot shaft 4, support shaft 4-1, pull ring 4-2, balancing member 5, limit pull rod 6, handle 7, support portion 8, snap-fit notch 9, ladder leg 10, frame hinge assembly 14, frame hinge outer assembly 14A, outer assembly shaft hole 14A-1, round hole 14A-2, frame hinge inner assembly 14B, inner assembly shaft hole 14B-1, pivot bracket 15, multi-axis hinge 16, first shaft hole 16-1, second shaft hole 16-2, arc-shaped hole 16-3, first rivet shaft 17, double-diameter rivet shaft 18, first isolation washer 19, first process washer 20, limit rivet 21, matching hole 22, second rivet shaft 23, lock catch 24, second isolation washer 25, second process washer 26, limit bar 27, limit stand 28, connection hole 29, third rivet shaft 30, spring 31, pressure buckle 32, third isolation washer 33, and recess 34, etc., the possibility of using other terms is not excluded. These terms are used only to more conveniently describe and explain the essence of the present invention; it is contrary to the spirit of the present invention to interpret them as any kind of additional limitation.

1. A foldable ladder, comprising two ladder frames rotatably connected at the top, and the ladder frames each include two ladder legs (10) arranged in parallel, and several steps (3) are arranged between the two parallel ladder legs (10); wherein a pair of frame hinge assemblies (14) are arranged between the two ladder frames, and the pair of frame hinge assembly (14) are relatively arranged on the two ladder legs (10) of the ladder frame; a balancing member (5) are provided on the frame hinge assembly (14), one end of the balancing member (5) is hinged with one frame hinge assembly (14), and the other end of the balancing member (5) is in locking connection with another frame hinge assembly (14); each frame hinge assembly (14) includes a frame hinge outer assembly (14A) and a frame hinge inner assembly (14B) connected to each other; the ladder leg (10) is further provided with a locking device for the balancing member (5).

2. The foldable ladder according to claim 1, wherein the frame hinge outer assembly (14A) and the frame hinge inner assembly (14B) are rotatably connected, and the frame hinge outer assembly (14A) and the frame hinge inner assembly (14B) are respectively arranged on two adjacent ladder legs (10), so that the two adjacent ladder legs of the two ladder frames are respectively connected to form a left leg frame (1) and a right leg frame (2); each step (3) is formed by a left step section (3-1) and a right step section (3-2) hingedly connected with each other, and the ends of the left step section (3-1) and the right step section (3-2) are rotatably connected with the ladder legs (10).

3. The foldable ladder according to claim 2, wherein the ladder legs (10) have a plurality of support portions (8) at different heights, and the two ends of each step (3) are respectively connected to the left leg frame (1) and the right leg frame (2) on the corresponding support portions (8); wherein the lengths of at least two steps (3) are substantially the same so that the left leg frame (1) and the right leg frame (2) are arranged in parallel, and the middle part of each step (3) is provided with a bendable structure; the two ends of each step (3) are hinged with the left leg frame (1) and the right leg frame (2) respectively;
when the step (3) is in the unfolded state, the two ends of the step (3) are respectively abutted against the left leg frame (1) and the right leg frame (2);
when the step (3) is in a folded state, the surfaces of the step (3) are respectively abutted against the left leg frame (1) and the right leg frame (2);
the top of the right leg frame (2) is provided with a balancing member (5) that is detachably connected to the top of the left leg frame (1); the middle of the steps (3) is provided with a step pivot shaft (4) connecting with the bendable structures of the steps (3).

4. The foldable ladder according to claim 3, wherein the tops of both ends of the step (3) are each formed with a snap-fit notch (9); the two step sections of each step (3) are respectively rotatably connected with the corresponding support portions (8); when the step (3) is in the unfolded state, the connection between the bottom of the snap-fit notch (9) and the step (3) is at the same level with the center of the adjacent support portion (8); and the extension lines of the two adjacent ladder legs (10) of the left leg frame (1) or the right leg frame (2) are arranged crosswise, and the frame hinge assembly (14) is arranged at the intersection of the two adjacent ladder legs (10), and between the adjacent ladder legs (10) of both the left leg frame (1) and the right leg frame (2) are each provided with a limit pull rod (6) with a bendable structure.

5. The foldable ladder according to claim 2, wherein the step pivot shaft (4) connects all steps (3) on the same ladder frame, and the left step section (3-1) and the right step section (3-2) are provided with connected support shafts (4-1), and the support shafts (4-1) pass through the corresponding step pivot shaft (4).

6. The foldable ladder according to claim 5, wherein when the left step section (3-1) and the right step section (3-2) are in the unfolded state, adjacent ends are abutted, and the left step section (3-1)) and the adjacent ends of the right step section (3-2) are formed with fitting grooves (3-3) which are adapted to the step pivot shaft (4); the left step section (3-1) and the right step section are (3-2) in a staggered arrangement, the left step section (3-1) and the right step section (3-2) are each formed with a notch groove (3-4) on one of the two side walls for easy rotation, and the top of the step pivot shaft (4) is provided with a pull ring (4-2), the top of the step pivot shaft (4) is flush with the surface of the uppermost step (3) when the step (3) is in use, the left leg frame (1) and the right leg frame (2) are each provided with a corresponding handle (7) in the middle.

7. The foldable ladder according to claim 1, wherein one end of the balancing member (5) is rotatably connected to a lock catch (24), the frame hinge assembly (14) which is in locking connection with one end of the balancing member (5) is provided with a matching double-diameter rivet shaft (18) thereon, and the lock catch (24) is matched with the frame hinge assembly (14).

8. The foldable ladder according to claim 1, wherein the locking device comprises a press buckle (32), a spring (31) and a third rivet shaft (30), the spring (31) and the press buckle (32) is sleeved on the third rivet shaft (30), and the spring (31) is in contact with the outer side of the press buckle (32), and the ladder leg (10) is formed with a connecting hole (29) adapted to the third rivet shaft (30); the frame hinge outer assembly (14A) and the frame hinge inner assembly (14B) are rotatably connected by a double-diameter rivet shaft (18).

9. The foldable ladder according to claim 1, wherein downwardly protruding limit bars (27) are oppositely provided under the balancing member (5), the top of each frame hinge assembly (14) is provided with two raised limit stands (28), and the length of the limit bar (27) is equal to the distance between the two limit stands (28) on the frame hinge assembly (14), and the outer side of the limit bar (27) is in contact with the inner side of the frame hinge assembly (14).

10. The foldable ladder according to claim 1, wherein the balancing member (5) is a tool tray, and the tool tray is formed with several small lattices and holes of different sizes and shapes.

11. The foldable ladder according to claim 10, wherein two pivot brackets are formed alongside one end of the balancing member (5), and between the two pivot brackets are provided with a multi-axis hinge (16) connected to the frame hinge assembly (14).

12. The foldable ladder according to claim 11, wherein the multi-axis hinge (16) comprises a hinge and a limit piece that are rotatably connected, and the hinge is formed with a first shaft hole (16-1) that communicates with the pivot bracket, and a first rivet shaft (17) is arranged in the first shaft hole (16-1), and the limit piece is rotatably connected to the frame hinge assembly (14), and a second shaft hole (16-2) and an arc-shaped hole (16-3) are formed on the limit piece, and the second shaft hole (16-2) is provided with a double-diameter rivet shaft that passes through the limit piece; the frame hinge outer assembly and the frame hinge inner assembly in sequence, and the frame hinge outer assembly is formed with a round hole (14A-2) communicating with the arc-shaped hole (16-3), and the arc-shaped hole (16-3)) is provided with a limit rivet (21) connected to the round hole (14A-2).

13. The foldable ladder according to claim 11, wherein the other end of the balancing member (5) is provided with a lock catch (24) and a second rivet shaft (23) passing through the lock catch (24), and the balancing member (5) is formed with a matching hole (22) that is adapted to the second rivet shaft (23); the lock catch (24) is rotatably connected to the end of the balancing member (5), and the lock catch (24) is adapted to the frame hinge assembly (14).

14. The foldable ladder according to claim 10, wherein the frame hinge outer assembly (14A) and the frame hinge inner assembly (14B) are rotatably connected, and the frame hinge outer assembly (14A) and the frame hinge inner assembly (14B) are respectively arranged on two adjacent ladder legs (10), so that the two adjacent ladder legs of the two ladder frames are respectively connected to form a left leg frame (1) and a right leg frame (2); each step (3) is formed by a left step section (3-1) and a right step section (3-2) hingedly connected with each other, and the ends of the left step section (3-1) and the right step section (3-2) are rotatably connected with the ladder legs (10).

15. The foldable ladder according to claim 14, wherein downwardly protruding limit bars (27) are oppositely provided under the balancing member (5), the top of each frame hinge assembly (14) is provided with two raised limit stands (28), and the length of the limit bar (27) is equal to the distance between the two limit stands (28) on the frame hinge assembly (14), and the outer side of the limit bar (27) is in contact with the inner side of the frame hinge assembly (14).

16. The foldable ladder according to claim 14, wherein the ladder legs (10) have a plurality of support portions (8) at different heights, and the two ends of each step (3) are respectively connected to the left leg frame (1) and the right leg frame (2) on the corresponding support portions (8); wherein the lengths of at least two steps (3) are substantially the same so that the left leg frame (1) and the right leg frame (2) are arranged in parallel, and the middle part of each step (3) is provided with a bendable structure; the two ends of each step (3) are hinged with the left leg frame (1) and the right leg frame (2) respectively;
wherein when the step (3) is in the unfolded state, the two ends of the step (3) are respectively abutted against the left leg frame (1) and the right leg frame (2);
wherein when the step (3) is in a folded state, the surface of the step (3) is respectively abutted against the left leg frame (1) and the right leg frame (2);
the top of the right leg frame (2) is provided with the balancing member (5) that is detachably connected to the top of the left leg frame (1); the middle of the steps (3) is provided with a step pivot shaft (4) connecting with the bendable structures of the steps (3).

17. The foldable ladder according to claim 3, wherein the tops of both ends of the step (3) are formed with snap-fit notches (9); the two step sections of each step (3) are respectively rotatably connected with the corresponding support portions (8); when the step (3) is in the unfolded state, the connection between the bottom of the snap-fit notch (9) and the step (3) is at the same level with the center of the adjacent support portion (8), and the extension lines of the two adjacent ladder legs (10) of the left leg frame (1) or the right leg frame (2) are arranged crosswise, and the frame hinge assembly (14) is arranged at the intersection of the two adjacent ladder legs (10), and between the adjacent ladder legs (10) of both the left leg frame (1) and the right leg frame (2) are each provided with a limit pull rod (6) with a bendable structure.

18. The foldable ladder according to claim 16, wherein the step pivot shaft (4) connects all steps (3) on the same ladder frame, and the left step section (3-1) and the right step section (3-2) are provided with connected support shafts (4-1), and the support shafts (4-1) pass through the corresponding step pivot shaft (4).

19. The foldable ladder according to claim 16, wherein when the left step section (3-1) and the right step section (3-2) are in the unfolded state, adjacent ends abut against each other, and the adjacent ends of the left step section (3-1) and the right step section (3-2) are formed with fitting grooves (3-3) which are adapted to the step pivot shaft (4); the left step section (3-1) and the right step section (3-2) are arranged alternately, and the left step section (3-1) and the right step section are each formed with a notch groove (3-4) on one of the two side walls for easy rotation; a pull ring (4-2) is provided at the top of the step pivot shaft (4), and when the step (3) is in use, the top of the step pivot shaft (4) is flush with the surface of the uppermost step (3); the left leg frame (1) and the right leg frame (2) are each provided with a handle (7) in the middle.
